(19) United States
(12) Patent Application Publication
(10) Pub. No.: US 2026/0343061 A1
(43) Pub. Date: Oct. 29, 2026

(54) INFORMATION PROCESSING APPARATUS, METHOD FOR CONTROLLING INFORMATION PROCESSING APPARATUS, AND NON-TRANSITORY COMPUTER READABLE MEDIUM

(71) Applicant: CANON KABUSHIKI KAISHA, Tokyo (JP)

(72) Inventor: SHOTA YAMAGUCHI, Tokyo (JP)

(21) Appl. No.: 19/466,116

(22) Filed: Jan. 30, 2026

(30) Foreign Application Priority Data
Feb. 12, 2025 (JP) 2025-020738

(51) Int. Cl. H04N 21/4725; H04N 21/2187; H04N 21/431; H04N 21/44

(52) U.S. Cl. CPC H04N 21/4725; H04N 21/2187; H04N 21/4316; H04N 21/44008

(57) ABSTRACT

An information processing apparatus includes a processor, and a memory storing a program which, when executed by the processor, causes the information processing apparatus to perform control processing such that in playback of a moving image in which haptic information of a subject is associated with a part of a period, a haptic sensation corresponding to the haptic information is provided to a viewer in the part of the period, and, when the moving image is played back not from a beginning of the part of the period but from a timing during or after the part of the period, a notification that the haptic information exists for the subject is provided to the viewer.

### BACKGROUND

### Field of the Technology

The present disclosure relates to an information processing apparatus, and more particularly to a technology for presenting to a viewer a haptic sensation obtained by a creator of a moving image.

### Description of the Related Art

Conventional techniques have been proposed for presenting to a viewer a haptic sensation associated with a moving image. For example, Japanese Patent Laid-Open No. 2019-125376 proposes recording, in association with a moving image, haptic information corresponding to a gesture in a moving image.

However, for example, in the distribution of a moving image, when haptic information obtained by the creator of the moving image is to be shared with viewers, merely outputting the haptic information in association with the moving image gives rise to a problem in that it becomes difficult to share the haptic information with viewers who join the distribution later. For example, for a viewer who starts playback of the moving image from the middle of the playback, it is conceivable that the topic related to the part of the moving image associated with the haptic information has already ended and the topic has moved on to another topic. In this case, for a viewer who starts playback of the moving image from the middle of the playback, it may be burdensome to review earlier portions of the moving image to check the haptic information while following the current topic.

### SUMMARY

The present disclosure provides a technology that allows a viewer who starts playback of a moving image from the middle of the playback to check haptic information

that has been presented before the start of the playback, while viewing the moving image.

According to some embodiments, an information processing apparatus includes a processor, and a memory storing a program which, when executed by the processor, causes the information processing apparatus to perform control processing such that in playback of a moving image in which haptic information of a subject is associated with a part of a period, a haptic sensation corresponding to the haptic information is provided to a viewer in the part of the period, and, when the moving image is played back not from a beginning of the part of the period but from a timing during or after the part of the period, a notification that the haptic information exists for the subject is provided to the viewer.

According to some embodiments, a method for controlling an information processing apparatus includes controlling the information processing apparatus to perform control processing such that in playback of a moving image in which haptic information related to a subject is associated with a part of a period, a haptic sensation corresponding to the haptic information is provided to a viewer during the part of the period, and, when the moving image is played back not from a beginning of the part of the period but from a timing during or after the part of the period, a notification that the haptic information exists for the subject is provided to the viewer.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an exemplary configuration of an information processing apparatus according to a first embodiment.

FIG. 2 is a flowchart for illustrating processing executed by the information processing apparatus according to the first embodiment.

FIGS. 3A and 3B are views each illustrating an example of how to detect a feature value of a subject according to the first embodiment.

FIGS. 4A and 4B are views each illustrating an example of a notification image according to the first embodiment.

FIG. 5 is a flowchart for illustrating the processing of step S207 in the first embodiment.

FIG. 6 is a flowchart for illustrating the processing of step S208 in the first embodiment.

### DESCRIPTION OF THE EMBODIMENTS

Preferred embodiments of the present disclosure will now be described in detail with reference to the accompanying drawings. The following embodiments are not intended to limit the scope of the claims. While a plurality of features are described in the embodiments, not all of the features are necessarily essential to the technology of the present disclosure, and the plurality of features may be combined with one another as appropriate. Furthermore, in the accompanying drawings, identical or similar components are denoted by the same reference numerals, and redundant descriptions are not provided.

### FIRST EMBODIMENT

An information processing apparatus according to a first preferred embodiment of the present disclosure will now be described with reference to the accompanying drawings. In the present embodiment, a subject in a moving image for which haptic information has been recorded is detected, and notification processing related to the haptic information is performed. It is assumed, in the following description, that the creator of the moving image is, for example, a distributor who performs live distribution using the moving image, and that the distributor distributes, in real time, the moving image that has been captured. Note, however, that the present embodiment is not limited to the use of a moving image during live distribution, and is also applicable to various forms in which a moving image is recorded together with haptic information, for example, when a previously captured moving image is edited to provide haptic information to viewers.

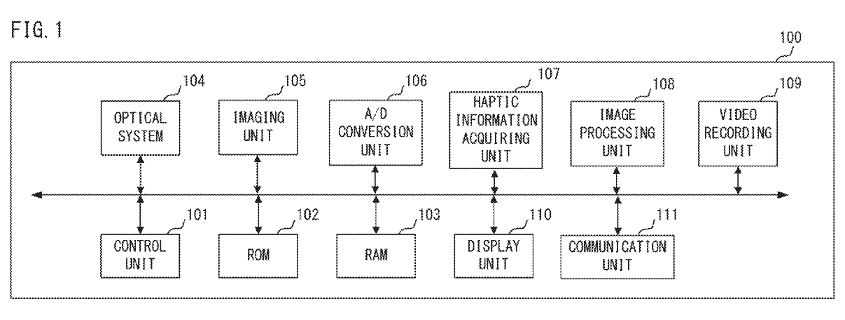

The information processing apparatus according to the embodiment will now be described in detail with reference to the accompanying drawings. FIG. 1 is a block diagram of an exemplary configuration of an information processing apparatus 100 according to the present embodiment. The exemplary configuration of the information processing apparatus 100 will be described with reference to FIG. 1.

A control unit 101 is, for example, a CPU (Central Processing Unit) and reads a control program for each block included in the information processing apparatus 100 from a ROM (Read-Only Memory) 102 as described below. The control unit 101 deploys the read program into a RAM (Random Access Memory) 103 as described below and executes the program. As a result, the control unit 101 controls operations of the blocks provided in the information processing apparatus 100.

The ROM 102 is an electrically erasable and recordable, non-volatile memory and stores a program for executing processing in the information processing apparatus 100 according to the present embodiment, operation programs for the respective blocks of the information processing apparatus 100, and parameters necessary for the operations of the blocks.

The RAM 103 is a rewritable volatile memory and is used to deploy a program to be executed in the information processing apparatus 100 and to temporarily record data generated by an operation of each block of the information processing apparatus 100. In the present embodiment, haptic information representing a tactile sensation obtained when the creator of the moving image touches an object is recorded in the RAM 103.

An optical system 104 includes a lens group having a zoom lens and a focus lens, and an aperture mechanism, and forms a subject image on an imaging surface of an imaging unit 105, which will be described below. The imaging unit 105 may be an imaging element such as a CCD (Charge-Coupled Device) or a CMOS (Complementary Metal Oxide Semiconductor) sensor. The imaging unit 105 photoelectrically converts the optical image formed on the imaging surface of the imaging unit 105 by the optical system 104 and outputs the obtained analog image signal to an A/D conversion unit 106.

The A/D conversion unit 106 converts the analog image signal input from the imaging unit 105 into digital image data for output. The digital image data output from the A/D conversion unit 106 is temporarily recorded in the RAM 103.

A haptic information acquiring unit 107 is, for example, a sensor worn on the finger of a distributor, who is a user of the information processing apparatus 100, and that acquires haptic information about an object that the distributor touches by means of the haptic information acquiring unit 107. Examples of the haptic information acquired by the haptic information acquiring unit 107 include information such as irregularity information on the surface of the object and temperature information, and the haptic information acquired by the haptic information acquiring unit 107 is temporarily recorded in the RAM 103.

An image processing unit 108 performs various kinds of image processing on the image data recorded in the RAM 103. Specifically, the image processing unit 108 applies various kinds of image processing for developing and displaying/recording digital image data, such as demosaicing processing, noise reduction processing, white-balance correction processing, and gamma processing. The image processing unit also detects a subject for which haptic information has been acquired and performs processing such as highlighting the detected subject. This processing will be described in detail later.

The video recording unit 109 includes therein a recording medium and records data including captured moving images onto the recording medium. A display unit 110 has a display device such as an LCD (Liquid Crystal Display). The display unit 110 displays on the display device, images recorded in the RAM 103 or moving images recorded in the video recording unit 109.

A communication unit 111 outputs image data generated by the image processing unit 108 or moving-image data recorded in the video recording unit 109 to an external monitor of the information processing apparatus 100 or to a video distribution application displayed on the display unit 110. The communication unit 111 communicates with a viewer’s information terminal and can transmit moving images and haptic information to the viewer’s information terminal and receive, from the viewer’s information terminal, information necessary for the processing which will be described below.

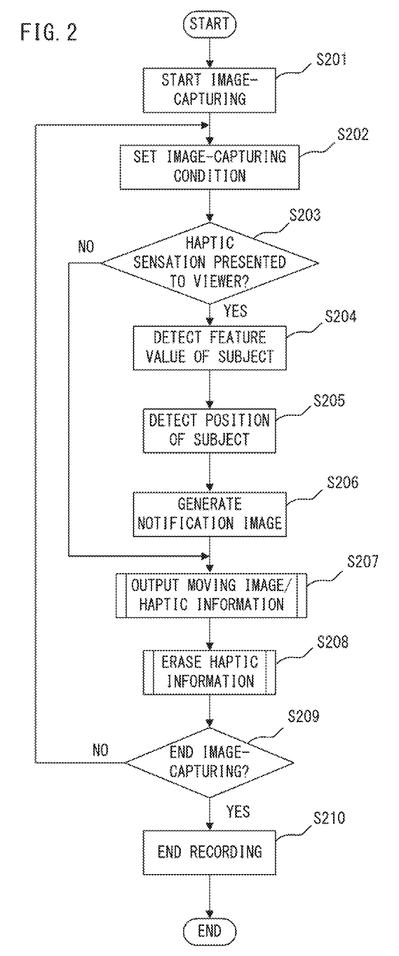

Next, in the present embodiment, an example of processing that is performed when the control unit 101 of the information processing apparatus 100 captures a moving image and outputs haptic information to a viewer of the captured moving image to provide the viewer with a haptic sensation will be described in detail with reference to the flowchart of FIG. 2. In the following description, it is assumed that the distributor of a moving image uses the information processing apparatus 100 to perform live distribution of the moving image to an unspecified large number of viewers.

First, in step S201, the control unit 101 starts capturing a moving image in response to an instruction from the distributor. Specifically, the control unit 101 starts moving-image capturing processing in response to an operation such as pressing, by the distributor, of a recording button provided in the information processing apparatus 100.

Next, in step S202, the control unit 101 sets image-capturing conditions in the image-capturing processing started in step S201. Here, the image-capturing conditions may include a shutter speed, an aperture value, and an ISO sensitivity of the information processing apparatus 100. As for a method for setting the image-capturing conditions, for example, the control unit 101 may set the image-capturing conditions in accordance with a program diagram recorded in the ROM 102 in advance, on the basis of brightness information of an image-capturing scene related to the started image-capturing. Alternatively, the control unit 101 may set the image-capturing conditions by receiving the image-capturing conditions designated by the distributor.

Next, in step S203, the control unit 101 determines whether to provide the viewer with a haptic sensation corresponding to the haptic information acquired by the haptic information acquiring unit 107. In the present embodiment, during playback of the moving image, the distributor acquires haptic information of an object, for example, a personal belonging or a pet, by using the haptic information acquiring unit 107 for a portion of the moving image in order to enhance a sense of presence with the viewer. The haptic information thus obtained is recorded in the RAM 103. The distributor makes a decision to provide the viewer with a haptic sensation corresponding to the recorded haptic information by using, for example, operation buttons of the information processing apparatus 100. As a result, during playback of the moving image in which haptic information of a subject is associated with a certain period of the moving image, the distributor, as the creator of the moving image, starts presenting the haptic sensation to the viewer.

The control unit 101 advances the processing to step S204 upon determining that a decision to present the haptic sensation to the viewer has been made (YES in S203). Meanwhile, the control unit 101 advances the processing to step S207 upon determining that no such decision has been made (NO in S203).

Next, in step S204, the control unit 101 detects a feature value of the subject for which the haptic information has been recorded, using images acquired by the imaging unit 105. Here, the feature value refers to information such as distribution information or average value information of pixel values represented by RGB or YUV regarding the subject for which the haptic information has been recorded. The details of a method for detecting the feature value of the subject in the image will be described below.

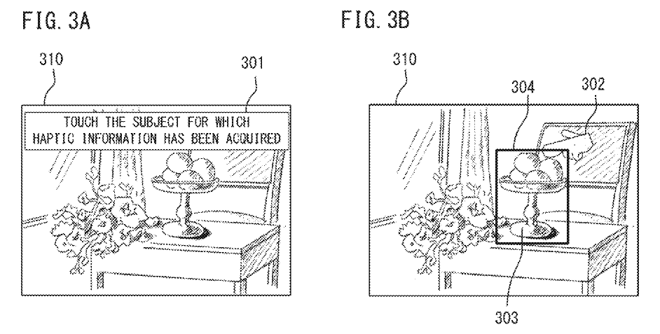

FIGS. 3A and 3B each illustrate an example of how to detect a feature value of a subject in the information processing apparatus 100. FIG. 3A illustrates an example of an image 310 displayed on the display unit 110 when the apparatus accepts a selection by the distributor of a subject for which haptic information has been acquired. As shown in FIG. 3A, in the image 310, a message 301 prompting the distributor to select the subject for which haptic information has been acquired is displayed. In FIG. 3A, when the distributor using the information processing apparatus 100 specifies, for example by a touch operation on the image displayed on the display unit 110, a subject for which haptic information has been acquired, the control unit 101 acquires a feature value of the specified subject.

FIG. 3B illustrates an example of an image displayed on the display unit 110 when the distributor specifies, by a touch operation within the image displayed on the display unit 110, the subject for which haptic information has been acquired. In FIG. 3B, a hand 302 that touches a subject 303 displayed on the display unit 110 by the distributor is schematically illustrated. As shown in FIG. 3B, in response to a touch operation on the display unit 110 performed by the distributor, the control unit 101 displays a frame 304 surrounding the subject 303 (a still life of fruit in the example of FIG. 3B) drawn at the touch position. In the example shown in FIG. 3B, the control unit 101 acquires a feature value of the subject 303 selected by the touch operation of the distributor and stores the acquired feature valueof the subject in the RAM 103.

Upon determining, on the basis of the information recorded in the RAM 103, that the feature value of the subject for which the haptic information has been acquired has already been obtained in a previous frame, the control unit 101 omits the processing of step S204. The method for acquiring the feature value of the subject in the present embodiment is not limited to the above. Other methods for specifying the feature value of the subject in the image may be used. For example, the control unit 101 may detect, by image processing, the distributor’s hand touching the subject in the moving image displayed on the display unit 110 and may determine a feature value of the subject being touched by the distributor’s hand on the basis of the detection result. This allows the control unit 101 to determine, in real time in the moving image, the feature value of the subject from which the distributor attempts to obtain the haptic sensation.

Next, in step S205, the control unit 101 detects the position of the subject in the moving image being captured on the basis of the feature value acquired in step S204. When the viewer has performed panning on the moving image being distributed, or when the subject for which haptic information has been acquired is an animal such as a pet, it is necessary to detect the position of the subject for each frame of the moving image because the subject moves during the distribution. Here, the position of the object includes coordinates of a center position of the subject and size information of the subject in the horizontal and vertical directions. The subject detection processing in this step may be processing for detecting the subject for each frame of the moving image by using the feature value. Alternatively, the subject detection processing in this step may be processing for detecting the subject in the moving image on the basis of a result of tracking the subject detected in a specific frame of the moving image.

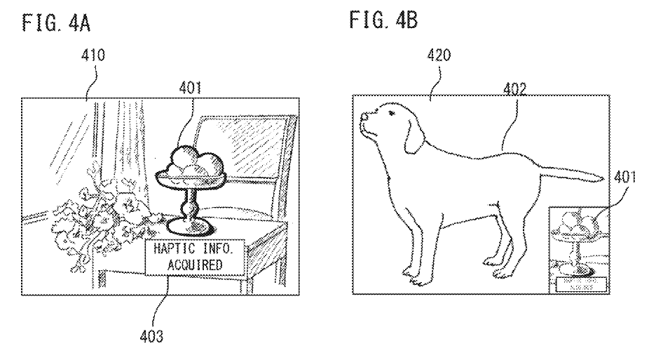

Next, in step S206, the control unit 101 controls the image processing unit 108 to generate a notification image for notifying that haptic information exists for the subject whose position has been detected in step S205 in the moving image being distributed. FIGS. 4A and 4B are views each illustrating an example of a notification image by the display unit 110 according to the present embodiment. In the image 410 shown in FIG. 4A, the image processing unit 108 performs prescribed peaking processing on a contour portion of a subject 401 for which haptic information has been acquired, so that the subject 401 is highlighted. In the image 410, a message 403 indicating that haptic information exists is displayed in the vicinity of the subject 401 by the image processing unit 108. This allows the information processing apparatus 100 to notify a viewer who views the moving image displayed on the display unit 110 that haptic information exists for the subject 401. The position information of the contour portion of the subject 401 in the image 410 is determined on the basis of the position of the subject detected in step S205.

The image 420 shown in FIG. 4B is an image displayed when, as a result of a topic shift concerning the image 410 in the moving image being distributed or panning of the camera, the subject 401 determined in step S203 to give the haptic sensation to the viewer has moved out of the moving image. As shown in FIG. 4B, a subject 402 different from the subject 401 is drawn in the image 420 displayed on the display unit 110. In this case, the control unit 101 causes the image processing unit 108 to superimpose an image of the subject 401, for which the haptic information has been acquired, on the image 420 of the currently displayed moving image. This allows the information processing apparatus 100 to notify the viewer, even when the subject 401 for which the haptic information has been acquired has moved out of the moving image and is no longer within the angle of view, that haptic information exists for the subject 401.

When the position of the subject 401 is not detected in step S205, the control unit 101 displays, for a prescribed period, a notification image that notifies the viewer that haptic information exists for the subject 401, such as the image in the image 420 illustrated in FIG. 4B. The method for generating a notification image about the haptic information for the subject is not limited to the methods illustrated in FIGS. 4A and 4B, and a feature image may be generated by another method.

Accordingly, when the moving image is played back not from the beginning of a part of the period with which the haptic information of the subject is associated, but from a timing during or after the part of the period, the control unit 101 provides the viewer with a notification that the haptic information exists for the subject.

Next, in step S207, the control unit 101 controls the communication unit 111 to output the moving image of the subject for which haptic information has been acquired and the acquired haptic information. In the present embodiment, the distributor can distribute the moving image on the Internet by using the information processing apparatus 100 via a live distribution application, for example, and output moving images and haptic information to the information terminals of an unspecified large number of viewers.

In the present embodiment, the control unit 101 controls the output of the moving image and the haptic information for each viewer on the basis of conditions such as whether the haptic information has already been output to the viewer. Therefore, the processing of step S207 as described below is executed for each viewer of the distributed moving image by the information processing apparatus 100. By executing the processing of step S207, the control unit 101 provides the haptic sensation corresponding to the haptic information to the viewer to whom the haptic information has been notified in response to a request from the viewer, when the moving image is played back from a timing after a part of the period with which the haptic information is associated.

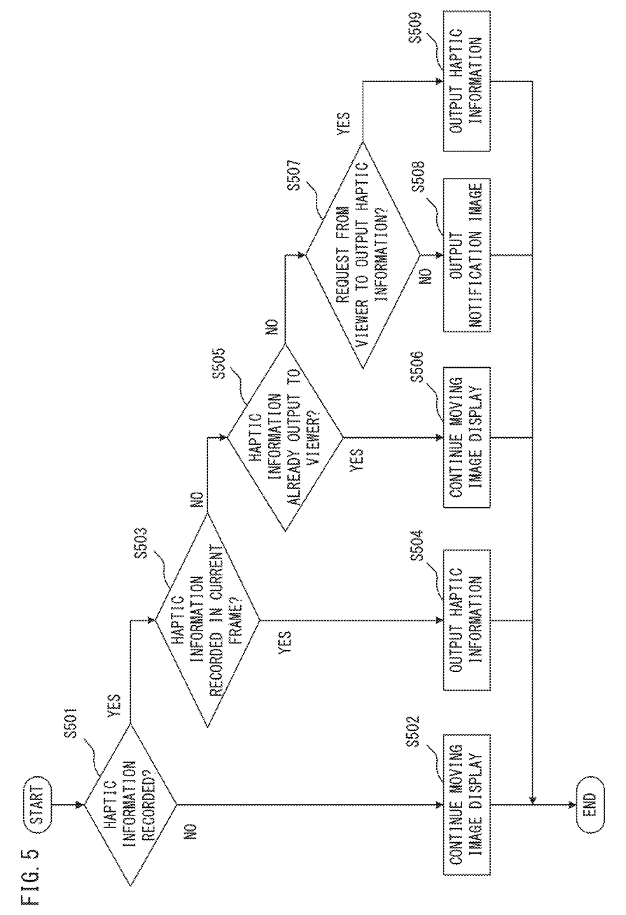

Hereinafter, details of the content of the processing of step S207 according to the present embodiment will be described. FIG. 5 is a flowchart for illustrating an example of processing in which the control unit 101 outputs the moving image and the haptic information in step S207.

First, in step S501, the control unit 101 determines whether haptic information is recorded in the RAM 103. Upon determining that haptic information is not recorded in the RAM 103 (NO in S501), the control unit 101 advances the processing to step S502. Meanwhile, upon determining that haptic information is recorded in the RAM 103 (YES in S501), the control unit 101 advances the processing to step S503.

In step S502, the control unit 101 continues the display of the moving image that is being distributed and does not output the notification image generated in step S206. Therefore, the notification images shown in FIGS. 4A and 4B are not displayed on the viewer’s information terminal, and the viewer can concentrate on viewing the moving image.

In step S503, the control unit 101 determines whether the haptic information determined in step S501 to have been recorded in the RAM 103 is information recorded in the current frame of the moving image. Upon determining that the haptic information is information recorded in the current frame (YES in S503), the control unit 101 advances the processing to step S504 because this corresponds to a case in which the haptic information is output in real time to provide the haptic sensation to the viewer. Meanwhile, upon determining that the haptic information is not information recorded in the current frame (NO in S503), the control unit 101 advances the processing to step S505.

In step S504, the control unit 101 continues the display of the moving image being distributed and outputs the haptic information. Further, in this step, the control unit 101 may perform image processing for displaying, on the viewer’s information terminal, the subject for which the haptic information is currently being output in an identifiable manner within the moving image being distributed. For example, as shown in FIG. 4A, the control unit 101 may highlight the contour of the subject for which the haptic information is currently being output and output the moving image to the viewer’s information terminal by the communication unit 111. In this way, another viewer who starts viewing while the haptic sensation is being provided can more easily recognize which subject is currently associated with the haptic sensation.

In step S505, the control unit 101 determines whether the haptic information determined in step S501 to have been recorded in the RAM 103 has already been output to the viewer. Upon determining that the haptic information has already been output to the viewer (YES in S505), the control unit 101 advances the processing to step S506 because there is no need to output a notification image to the viewer. Meanwhile, upon determining that the haptic information has not yet been output to the viewer (NO in S505), the control unit 101 advances the processing to step S507.

In step S506, because the viewer has already been provided with the haptic sensation in the past and there is no need to notify the viewer again that the haptic information exists, the control unit 101 continues the display of the moving image being distributed. The control unit 101 does not output the notification image.

In step S507, the control unit 101 determines whether a request to output the haptic information has been received from the viewer. Upon determining that no request to output the haptic information has been received from the viewer (NO in S507), the control unit 101 advances the processing to step S508 to notify the viewer that the haptic information exists. Meanwhile, upon determining that a request to output the haptic information has been received from the viewer (YES in S507), the control unit 101 advances the processing to step S509.

In step S508, the control unit 101 outputs the notification image generated in step S206 within the moving image being distributed. In this way, the viewer can recognize that haptic information exists for the subject specified by the distributor while viewing the moving image. In step S509, the control unit 101 continues the display of the moving image being distributed and outputs the haptic information to the viewer who has made the request to output the haptic information in step S507.

In the present embodiment, in the above example, the moving image being distributed is output to the viewer to whom the haptic information has already been output, but the control unit 101 may control the communication unit 111 to accept, from each viewer’s information terminal, a selection as to whether to output the notification image. In this way, the viewer provided with the haptic information is notified again of the existence of the haptic information, so that the viewer can check the haptic information again while viewing the moving image being distributed.

Next, referring back to the flowchart of FIG. 2, in step S208, the control unit 101 performs processing for erasing the haptic information recorded in the RAM 103. Hereinafter, details of the processing executed by the control unit 101 in step S208 will be described.

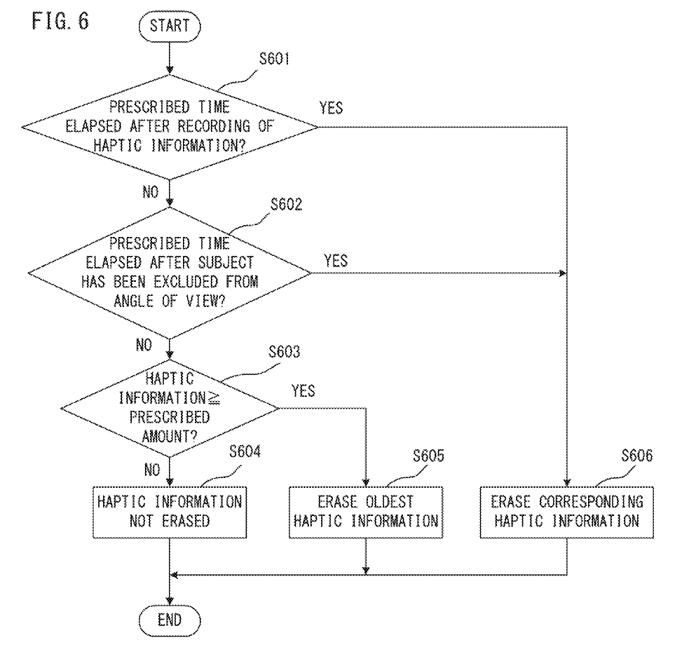

FIG. 6 is a flowchart for illustrating an example of processing executed in step S208.

First, in step S601, the control unit 101 checks the haptic information recorded in the RAM 103 and determines, for each item of haptic information, whether a prescribed time has elapsed since the recording of the haptic information. The prescribed time used for the determination in this step may be determined as appropriate in advance according to, for example, the storage capacity of the RAM 103. Upon determining that the prescribed time has elapsed since the recording of the haptic information (YES in S601), the control unit 101 advances the processing to step S606. Meanwhile, upon determining that the prescribed time has not elapsed since the recording of the haptic information (NO in S601), the control unit 101 advances the processing to step S602.

In step S602, the control unit 101 determines, in the moving image being distributed, whether a prescribed time has elapsed since the subject for which the haptic information has been acquired has become excluded from the angle of view. The prescribed time used for the determination in this step may be determined as appropriate in advance according to the storage capacity of the RAM 103, for example. Upon determining that the prescribed time has elapsed since the subject for which the haptic information has been acquired has become excluded from the angle of view of the moving image (YES in S602), the control unit 101 advances the processing to step S606. Meanwhile, upon determining that the prescribed time has not elapsed since the subject for which the haptic information has been acquired has become excluded from the angle of view of the moving image (NO in S602), the control unit 101 advances the processing to step S603.

In step S603, the control unit 101 determines whether the amount of haptic information recorded in the RAM 103 has reached a prescribed amount or more. The prescribed amount of haptic information used for the determination in this step may be determined as appropriate in advance according to the storage capacity of the RAM 103, for example. Upon determining that the amount of haptic information recorded in the RAM 103 has reached the prescribed amount or more (YES in S603), the control unit 101 advances the processing to step S605. Meanwhile, upon determining that the amount of haptic information recorded in the RAM 103 is less than the prescribed amount (NO in S603), the control unit 101 advances the processing to step S604.

In step S604, the control unit 101 ends the processing of the flowchart without erasing the haptic information recorded in the RAM 103 and advances the processing to step S209. In step S605, the control unit 101 erases, with priority, the oldest haptic information among the haptic information recorded in the RAM 103. As a result, the haptic information recorded in the RAM 103 is erased in order from the oldest. The control unit 101 then advances the processing to step S209. In step S606, the control unit 101 erases, from the RAM 103, the haptic information for which it is determined in step S601 that the prescribed time has elapsed since its acquisition. Alternatively, the control unit 101 erases, from the RAM 103, the haptic information for the subject that is determined in step S602 to have been excluded from the angle of view of the moving image for a prescribed time. Then, the control unit 101 advances the processing to step S209.

Next, in step S209, the control unit 101 determines whether to end image-capturing of the moving image. For example, in the information processing apparatus 100, the distributor issues an instruction to end image-capturing of the moving image by pressing a moving-image image-capturing button. In step S209, upon determining that image-capturing of the moving image is to be ended (YES in S209), the control unit 101 advances the processing to step S210. Meanwhile, in step S209, upon determining that image-capturing of the moving image is not to be ended (NO in S209), the control unit 101 returns the processing to step S202 to continue image-capturing of the moving image.

In step S210, the control unit 101 ends the image-capturing of the moving image and the recording of the haptic information and ends the processing of this flowchart.

In this way, in the information processing apparatus 100 according to the embodiment, the distributor acquires the haptic sensation of a subject during a part of the period of the moving image and determines to present the haptic sensation to the viewer. The information processing apparatus 100 can notify the viewer who starts playback of the moving image from a timing during or after a part of the period of the moving image that the haptic information exists. As a result, the notified viewer can check, in real time while viewing the moving image being distributed, the haptic sensation that was presented in the past.

Further, according to the information processing apparatus 100 of the present embodiment, even when the haptic sensation is being presented to a viewer in the moving image being distributed and another viewer starts viewing the distribution midway, the existence of the haptic information is notified to the viewer who joined midway. Therefore, the viewer who starts viewing the distribution midway can recognize to which subject the haptic sensation currently being presented relates.

In the examples of FIGS. 4A and 4B, as a notification image of the haptic information, the contour of the subject corresponding to the haptic information is highlighted in the moving image, or an image for notifying that the haptic information exists for the subject is displayed at the corner of the screen. However, the method for notifying the viewer that haptic information exists is not limited to these examples. For example, in step S508, the control unit 101 may control the communication unit 111 to output the notification image to the viewer’s information terminal and may also control the transmission of an instruction to output haptic feedback on the viewer’s information terminal in accordance with the display of the notification image. In this way, the viewer can recognize that haptic information exists for the subject while viewing the moving image.

Further, in the foregoing description, it is assumed that in the information processing apparatus 100 according to the present embodiment, the haptic sensation of a subject is provided to the viewer when the distributor performs live distribution of a moving image. However, the present embodiment may be applied to other cases. In the present embodiment, it is sufficient that, when playback of the moving image is started from a timing during or after a period in which the haptic sensation is provided, notification of the haptic information is provided to the viewer of the moving image. That is, the present embodiment can be applied not only to a moving image that is live-distributed, but also to playback of a moving image distributed in a non-live distribution format or a moving image recorded on a medium such as a Blu-ray Disc. Therefore, the configuration and processing of the information processing apparatus 100 of the present embodiment can be applied both to equipment (distribution device) used by the distributor of the moving image and to equipment (playback device) used by the viewer of the moving image.

Further, for example, when the user of the information processing apparatus 100, as a creator of a moving image, edits a captured moving image and provides the viewer with a haptic sensation of a subject at a desired timing or period of time, the configuration and processing described above of the present embodiment can be applied. In this case, similarly to the above, when the viewer starts playback of a moving image from a point of time after a timing or a period in which a haptic sensation is provided, notification that the haptic information of the subject exists is provided to the viewer during the playback of the moving image. Also, for example, when the information processing apparatus 100 broadcasts a moving image, it is possible to notify the viewer of haptic information and present a haptic sensation to the viewer in the same manner as described above.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense and includes general- purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the technology of the present disclosure, the viewer of a moving image can check haptic information presented in the past earlier than the start of the playback of the moving image while viewing the moving image when the viewer starts playback of the moving image halfway.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020738, filed on Feb. 12, 2025, which is hereby incorporated by reference herein in its entirety.

What is claimed is:

1. An information processing apparatus comprising:
a processor; and
a memory storing a program which, when executed by the processor, causes the information processing apparatus to perform:
control processing such that in playback of a moving image in which haptic information of a subject is associated with a part of a period, a haptic sensation corresponding to the haptic information is provided to a viewer in the part of the period, and, when the moving image is played back not from a beginning of the part of the period but from a timing during or after the part of the period, a notification that the haptic information exists for the subject is provided to the viewer.

2. The information processing apparatus according to claim 1, wherein in the control processing, control is performed such that when the moving image is played back not from the beginning of the part of the period but from the timing during or after the part of the period, the haptic sensation corresponding to the haptic information is provided to the viewer in response to a request from the viewer while the notification is being provided.

3. The information processing apparatus according to claim 2, wherein in the control processing, control is performed such that, after the haptic sensation corresponding to the haptic information is provided to the viewer in response to the request from the viewer, the notification is not provided to the viewer.

4. The information processing apparatus according to claim 1, wherein in the control processing, control is performed such that the notification is provided to the viewer when the viewer has not been provided with the haptic sensation.

5. The information processing apparatus according to claim 1, wherein in the control processing, control is performed such that the notification is not provided to the viewer when the viewer has been provided with the haptic sensation.

6. The information processing apparatus according to claim 1, wherein in the control processing, control is performed such that a selection of whether to provide the notification to the viewer is received from the viewer when the viewer has been provided with the haptic sensation.

7. The information processing apparatus according to claim 1, wherein the moving image is being live-distributed.

8. The information processing apparatus according to claim 1, wherein the program, when executed by the processor, further causes the information processing apparatus to perform:
detection processing that detects the subject in the moving image using a feature value related to the subject in the moving image, and
in the control processing, control is performed such that the notification provided to the viewer is notification that haptic information exists for the detected subject.

9. The information processing apparatus according to claim 1, wherein the program, when executed by the processor, further causes the information processing apparatus to perform:
detection processing that detects the subject in the moving image on the basis of a result of tracking the subject in the moving image, and
in the control processing, control is performed such that the notification provided to the viewer is notification that the haptic information exists for the detected subject.

10. The information processing apparatus according to claim 1, wherein in the control processing, control is performed such that the notification is provided to the viewer by highlighting the subject corresponding to the haptic information.

11. The information processing apparatus according to claim 1, wherein in the control processing, control is performed such that the notification is provided to the viewer by displaying an image of the subject in the moving image when the subject has become excluded from an angle of view of the moving image after the part of the period in the moving image.

12. The information processing apparatus according to claim 1, wherein
in the control processing, control is performed such that the notification is provided to the viewer using haptic feedback.

13. The information processing apparatus according to claim 1, wherein the program, when executed by the processor, further causes the information processing apparatus to perform:
recording processing that records the haptic information, and
erasing processing that erases the haptic information recorded by the recording processing when a prescribed amount of time has elapsed after the recording of the haptic information by the recording processing.

14. The information processing apparatus according to claim 1, wherein the program, when executed by the processor, further causes the information processing apparatus to perform:
recording processing that records the haptic information, and
erasing processing that erases the haptic information recorded by the recording processing when a prescribed amount of time has elapsed after the subject has become excluded from an angle of view of the moving image.

15. The information processing apparatus according to claim 1, wherein the program, when executed by the processor, further causes the information processing apparatus to perform:
recording processing that records the haptic information, and
erasing processing that erases, with priority, haptic information that is oldest among the haptic information recorded by the recording processing when an amount of the recorded haptic information is a prescribed amount or more.

16. A method for controlling an information processing apparatus, the method comprising:
controlling the information processing apparatus to perform control processing such that in playback of a moving image in which haptic information related to a subject is associated with a part of a period, a haptic sensation corresponding to the haptic information is provided to a viewer during the part of the period, and, when the moving image is played back not from a beginning of the part of the period but from a timing during or after the part of the period, a notification that the haptic information exists for the subject is provided to the viewer.

17. A non-transitory computer readable medium that stores a program, wherein the program causes a computer to execute a control method of an information processing apparatus, the control method comprising:
performing control processing such that, in playback of a moving image in which haptic information related to a subject is associated with a part of a period, a haptic sensation corresponding to the haptic information is provided to a viewer during the part of the period, and when the moving image is played back not from a beginning of the part of the period but from a timing during or after the part of the period, a notification that the haptic information exists for the subject is provided to the viewer.
